(19) United States
(12) Patent Application Publication
(10) Pub. No.: US 2007/0021972 A1
(43) Pub. Date: Jan. 25, 2007

(54) Bluebook compliant passive protection

(76) Inventors: Eric Vandewater, Scottsdale, AZ (US); Edward Heldman, Scottsdale, AZ (US)

Correspondence Address: Michal Avniel;SunnComm Int'l, Ste. 248, 668 N. 44th St., Phoenix, AZ, 85008, US

(21) Appl. No.: 11/481,766

(22) Filed: Jul. 6, 2006

Related U.S. Application Data
(60) Provisional application No. 60/697,159, filed on Jul. 7, 2005.

(51) Int. Cl. G06Q 99/00

(52) U.S. Cl. 705/1

(57) ABSTRACT

A multiple session optical disc has a first audio session and one or more additional data sessions wherein at least one of the data sessions contain a data track as the first track and an extra audio or data track. When reading data from an optical disc in a computer a user will use a media player applications to access the audio content on the optical disc. It has been found that at least some application media players do not play audio content from said multiple session optical disc.

### BACKGROUND TO THE INVENTION

The present invention relates to copy protected optical discs and to a method of controlling access to data on an optical disc. In particular, an optical disc contains multiple sessions where the first session is an audio session that contains only audio tracks and one of the additional sessions starts with a data track followed by additional audio and/or data tracks. The addition of the audio and/or data track to the data session prevents a media player on the computer from recognizing this as a disc that contains audio and will therefore not play the audio content

The widespread use of personal computers and Internet access has permitted extensive unauthorized digital extraction, reproduction and distribution of a significant amount of artistic content, including audio, video, software, images and text. Significant contributing factors to this unauthorized distribution include the large volume of digital content that has been made available to consumers in formats such as audio CD, CD-ROM, CD-R, DVD and DVD-R media and the ease of digital extraction and duplication of the music or other content on these physical media. Unfortunately, the standards used to produce the content for audio CDs (e.g., the IEC 60908 Redbook Standard) were not originally intended to prevent transfer of the content in digital or analog form and do not use methods to conceal the digital data on the CD for preventing unauthorized transfer. Further, copies made using digital processes are of high quality. Even copies using compressed formats such as, for example the standard MPEG Audio Layer 3 (MP3) format or Microsoft's Windows®. Media (WMA) format, are of good quality in comparison to prior analog copying approaches. [0003] The music industry in particular has a strong interest in protecting its proprietary works from unauthorized copying and distribution, especially over the Internet or through other computer-based copying and distribution using music ripping software or other techniques. A number of attempts have been made by the music industry to provide music CDs that can be reliably played in consumer CD players but that somehow are resistant to digital audio extraction by a personal computer. Although there has been some success in this area, anything less than 100 percent playability by the wide array of consumer CD players that are already in use is extremely undesirable. When a consumer purchases a new CD he or she expects it to play in his or her equipment, and there is a great amount of anger and frustration if it does not. The record industry is extremely reluctant to take the rest of this happening to its end consumers who appropriately purchase its music offerings. In addition, the reliability of protection against unauthorized copying and other digital extraction provided by the techniques that have been so far developed by the industry has been haphazard, being highly dependent upon specific hardware characteristics, firmware versions and countermeasures that have been employed by various forms of software. Another disadvantage of such technology is that it prevents a consumer who has legitimately purchased a compact disc from playing music files from the compact disc using his or her computer. Many consumers who purchase music on compact discs expect to be able to play them on their computers, or at least to extract the music to their hard drives using software that contains a digital rights management protocol, such as Windows Media Player®.

Copy protection technologies typically use a CD layout where a first session (Session 1) contains Redbook compliant audio tracks only and a second session (Session 2) that contains exactly one single data track for computer use. Such a format is compliant with the Enhanced CD format as specified in the Sony/Philips Blue Book standard. Media player software is designed to recognize either a single session disc with audio only or a multi-session disc with the layout described above.

There are basically two ways to copy protect digital content on an optical disc such as a digital audio compact discs. One way is generally referred to as passive protection and involves modifying the data structures on the discs that are inconsistent or incompatible with the published standards such as the Redbook standard for audio CDs. These modifications involve changes in essential control data stored on the disc, such as the Lead-In, Lead-Out, Table Of Contents (TOC) and sub-channels. These modifications or errors prevent copying in many PC configurations but a serious drawback is that these modifications also prevent some CD players from playing the CDs. The music industry and consumers of music demand a zero tolerance with respect to incompatibility with CD players. In other words, any copy protection system must be able to play the protected CD in all CD players, ie, home stereos, boom boxes, portable personal CD players, car CD players, video game systems and the like.

The second way to copy protect a CD is typically referred to as active protection. The concept is to incorporate software onto the CD that is downloaded to a computer when the CD is inserted into the computer drive. The software downloaded onto the PC then regulates what can and cannot be done with the protected digital content on the CD. When a copy protected CD with active protection is inserted into a PC many operating systems, such as Windows, have autorun features that automatically starts software programs present on the CD. The software programs downloaded from the CD allow only permitted and authorized uses of the digital content on the CD. For example, copy protections software can prohibit extraction of the CD-DA tracks by ripping software, but allow the burning of a limited number of CD copies for personal use employing digital rights management (DRM) technologies and allowing for the downloading of DRM protected music files onto the PC for playing on the PC via media player software.

A downside of active protection is the dependency on software that needs to be installed on the computer before the protection will be effective. Active protection is typically delivered from the CD. If installation from the CD is prevented, for instance, by holding down the shift-key on some computer systems, the user may obtain access to the first session Redbook audio files without the protection provided by the copy protection software on the CD.

Published US Patent Application 2005/0099921 A1 (“921 Application”) discloses alternative copy protection methods for multiple session optical discs. The copy protected optical discs of the 921 Application have a first audio session that contains Redbook compliant audio files and a second data session that contains errors. The errors are typically made to the TOC in the Lead-In area of the second session. When the information on the disc is interpreted by a CD file system program the errors are identified and the CD file system program prevents drivers provided between a port driver and the player from passing on the audio tracks to the player.

The errors made to CDs according to the '921 application make the CD production process more difficult. Production facilities typically receive CD's to be mastered in electronic form using a standard format called DDP. This DDP format does not provide a means to include those types of errors however. As a result, special processing and handling at the production plant are necessary to make discs having errors. When a copy protected disc remains Bluebook compliant, the protected CD can be produced just like any other regular CD without special treatment at the plant.

A need exists for an improved system and method for protecting digital content that does not adversely affect playability, that reliably prevents unauthorized duplication of digital content and that furthermore provides consumers an opportunity to play music that they have purchased on their personal computers (PC). The solution should also be less software dependent and Bluebook compliant.

The present invention provides a solution to the problem of being able to avoid the copy protection software of an active protected optical disc by preventing the software on the CD to install. The solution is provided that is Bluebook compliant and without the need to incorporate errors into the information on the optical disc. The present invention also has the advantage of not requiring any special processing during the CD manufacturing process because the information to be transferred to the CD can be stored in the standard DDP file format used by CD manufacturers.

### SUMMARY OF THE INVENTION

Briefly, in accordance with the present invention, a digital audio CD is made with multiple sessions wherein the first session is an audio session that contains one or more audio tracks. At least one additional session is present that starts with a data track but is followed by one ore more audio and/or data tracks or sessions. The addition of extra track(s) to the data session or the addition of extra sessions prevents at least some media players from recognizing the disc as a playable audio CD. Even if no active protection software is installed on the computer, at least some media player software will not allow the user to play the regular audio content. The copy protected CD can have more than two sessions but a first audio session and a second data session are preferred. The data session can have 2 or more audio tracks but it is preferred to have only one audio track which is all that is needed to perform the function of preventing the protected content from being played on the media player.

Of particular interest in practicing the present invention, a copy protected digital audio CD is made wherein the CD has two sessions. The first session is an audio session that contains one or more audio tracks. The second session is a data session that contains a data track as the first track and one audio track and preferably only one audio track.

### BRIEF DESCRIPTION OF THE DRAWINGS

Embodiments of the present invention will hereinafter be described, by way of example, with reference to the accompanying drawing, in which

FIG. 1 is a chart showing various configurations of an audio CD where various tracks in the first and second session are identified. “A” represents an audio track and “D” a data track.

### DESCRIPTION OF PREFERRED EMBODIMENTS

In practicing the present invention a digital audio CD is made having two or more sessions. The first session is an audio session structured in accordance with a well known standard format such as the Redbook standards (IEC 60908). Any CD made in accordance with the Redbook standards will play on any audio player made to the Redbook standard. The first sessions contains only audio tracks. At least one additional session is present on the CD that starts with a data track but is followed by one ore more audio and/or data tracks. The addition of the audio and/or data track to the data session prevents a media player on the computer from recognizing this as a disc that contains audio and will therefore not play the audio content.

Multiple session CDs contain two or more sessions arranged sequentially along the spiral track of the disc from the inner area near the center hole in the disc to the outer area of the disc near the outer edge. Each session has a lead-in and a lead-out which flank a program area. A session can be an audio session or a data session and is controlled by control data all according to known standards. The Bluebook standard defines an enhanced music CD disc as a multi-session disc with two sessions. The first session is an audio session and the second session is a CD-ROM XA session. A session is an area on a disc starting with a Lead-In (LI), area followed by a program area and ending with a Lead-Out (LO) area. The program area of a session contains tracks which are contiguous areas on the disc with one and the same track number. A track can be an audio track or a data track. An audio track contains CD audio information according to the Redbook standards. A data track contains sectorized data according to the Yellow Book standard. The Bluebook further defines a data session as a session that has a data track as the first track in the program area while audio sessions contain only audio tracks in the program area of the audio session. As mentioned above an enhanced music CD that contains a CD-ROM XA session as the second session. A CD-ROM-XA session is a session wherein the first tack in the program area of the session is a CD-ROM XA track. A CD-ROM XA track is a data track that contains sectors in the Mode 2 Form 1 and/or 2 format according to the CD-ROM XA specification.

The specific content of the first audio session is not critical to the practice of the present invention and, of course, can be any desired audio work. The specific content of the second data session is not critical to the practice of the present invention either in that it too can contain any data such as advertising material, software programs used for copy protection, videos, pictures and the like. See for example co-pending application Ser. Nos. 10/304,259, 10/412,453, and 10/868,576 all of which are incorporated herein by reference.

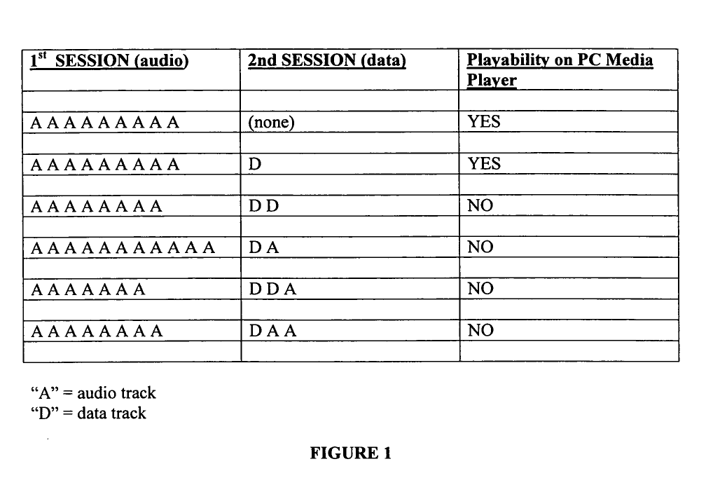

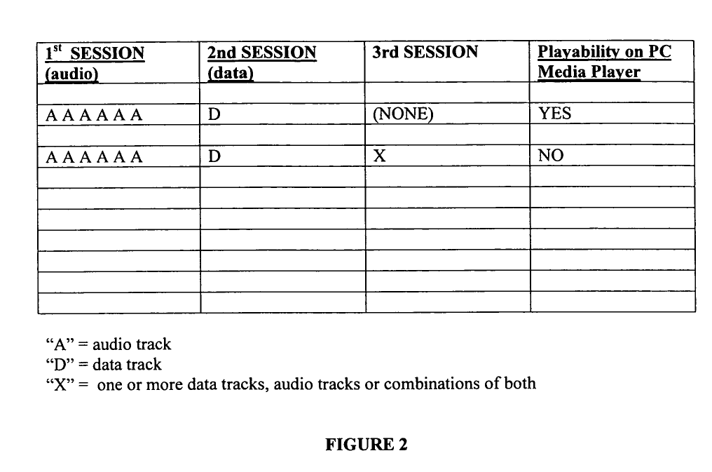

Once the content of the CD is determined the CD is made with a first audio session that contains one or more audio tracks and one or more additional sessions wherein said one or more additional sessions contain a data track as the first track of said session followed by at least one extra audio or data track or both. FIG. 1 is a table showing several variations of CDs and their playability by a media player installed on a PC when the CD is inserted into the computer drive. The top two variations are prior art configured CDs that both play on the media player of the PC. The top configuration is a standard one session Redbook audio CD and is played by the media player. The second configuration containing only a single Data file in the second session also plays in the media player of the PC. The bottom four configurations will not play in the media player of the PC because each of the bottom four configurations contains an extra Data track and/or Audio track in addition to the first data track. In other embodiments one could put 3, 4 or more sessions on the CD and as long as one of those additional sessions started with a data track and also contained one or more additional data and/or audio track then the CD will not play in the media player of a PC.

In a preferred embodiment of the present invention an enhanced music CD disc containing two sessions is made according to Bluebook standards wherein the first session is a an audio session and the second session is a data session that has copy protection software that is automatically downloaded onto the PC by an autorun feature or activated manually by the user. The second session starts out with a data track containing the copy protection software and then is followed by an audio track. The audio track can be any audio track and is preferably a silent audio track of at least 4 seconds. In operation, this preferred embodiment works as follows:

a. if the autorun feature of the PC is enabled the copy protection software will download onto the PC and control access to and playing of the Redbook audio contained in the first session; or

b. if the autorun feature is disabled the copy protection software will not download to the computer; the operating system will then recognize the CD as unplayable because of the additional audio track present in the second session; or

c. if the SHIFT key is held down while the CD is being inserted into the PC and the SHIFT key is held down to suspend the running of the autorun feature then the operating system will recognize the CD as unplayable because of the additional audio track present in the second session.

The above description describes several embodiment of the present invention and should not be construed to limit the scope of the inventions described in the following claims.

In another embodiment of the present invention a copy protected music CD can also be made with more than 2 sessions. In this regard this embodiment will not be compliant with the Bluebook standard but it will achieve the same copy protection as the Bluebook compliant CDs described herein and it will not adversely effect the CD production process relating to the DDP format like other copy protection processes that include errors. In this embodiment the CD is made having a first audio session compliant with Redbook standards, a second data session that is a CD-ROM XA session and one or more additional sessions that are formatted in any manner desired. In operation, this alternative embodiment works as follows:

a. if the autorun feature of the PC is enabled the copy protection software will download onto the PC and control access to and playing of the Redbook audio contained in the first session; or

b. if the autorun feature is disabled the copy protection software will not download to the computer; the operating system will then recognize the CD as unplayable because of the additional third, fourth, etc. sessions; or

c. if the SHIFT key is held down while the CD is being inserted into the PC and the SHIFT key is held down to suspend the running of the autorun feature then the operating system will recognize the CD as unplayable because of the additional third, fourth, etc sessions.

FIG. 2 is a table showing two variations of CDs and their playability by a media player installed on a PC when the CD is inserted into the computer drive. The top variation is a prior art two session Bluebook compliant enhanced music CD disc that plays on the media player of the PC. The bottom configurations will not play in the media player of the PC because of the presence of the third session following the data session. In other embodiments one could put a fourth, fifth or more sessions on the CD. A CD with a data session followed by 1 or more sessions will not play in at least some media players of a PC.

In a further embodiment of the present invention the first data track in the CD-ROM XA session described above for the second session can be made in Mode 1 instead of the Bluebook standard of Mode 2, form 1 or form 2. While this further embodiment would make the CD non-compliant with the Bluebook standard it will provide the same copy protection function as described herein for Bluebook compliant versions of the present invention and the copy protection provided by the non-compliant enhanced music CDs that contain 3 or more sessions. Additionally, using Mode 1 instead of Mode 2 will also not adversely effect the CD production process relating to the DDP format requirements.

What we claim is:

1. An enhanced audio CD comprising:
(a) a first session that contains one or more audio tracks and
(b) one or more additional sessions wherein said one or more additional sessions contain a data track as the first track of said session followed by at least one extra audio or data track or both.

2. The enhanced audio CD of claim 1 wherein the CD has 2 sessions and the second session contains a data track as the first track of said session and at least one extra audio track.

3. The enhanced audio CD of claim 1 wherein the CD has 2 sessions and the second session contains a data track as the first track of said session and two or more audio tracks.

4. The enhanced audio CD of claim 1 wherein the first session is Redbook compliant.

5. The enhanced audio CD of claim 1 wherein the first track of the second session is a Yellowbook compliant data track.

6. The enhanced audio CD of claim 1 wherein no informational errors exist on the CD to make the CD non-compliant with Redbook, Yellowbook or Bluebook standards.

7. The enhanced audio CD of claim 6 wherein information on the CD can be stored in a standard DDP file format and produced in a CD production facility without any special production requirements.

8. A method of limiting access to audio tracks on an enhanced audio CD which comprises making a multiple session enhanced audio CD having a first session and one or more additional sessions wherein the first session is an audio session and any additional sessions contain a data track as the first track at least one extra audio or data track.

9. The method of claim 8 wherein the digital audio CD contains two sessions and the second session contains a data track as the first track of said session and at least one extra audio track.

10. The method of claim 8 wherein the digital audio CD contains two sessions and the second session contains a data track as the first track of said session and two or more audio tracks.

11. The method of claim 8 wherein the first session is Redbook compliant.

12. The method of claim 9 wherein the second session contains one audio track.

13. The method of claim 8 wherein no informational errors exist on the CD to make the CD non-compliant with Redbook, Yellowbook or Bluebook standards.

14. The method of claim 13 wherein information on the CD can be stored in a standard DDP file format and produced in a CD production facility without any special production requirements.

15. In a method of limiting access to audio tracks on a multiple session digital audio CD that contains a first audio session and one or more additional data sessions, the improvement which comprised adding at least one audio track or at least one data track to one of the data sessions wherein the data session begins with a data track.

16. In an enhanced audio CD containing a first audio session and a second data session starting with a data track, the improvement which comprises adding at least one audio track or at least one data track to the second session.

17. An enhanced audio CD comprising:
a. a first session that contains one or more audio tracks,
b. a second session that contains a data track and
(c) one or more additional sessions.

18. The enhanced audio CD of claim 17 wherein the first session is Redbook compliant.

19. The enhanced audio CD of claim 17 wherein the first track of the second session is a Yellowbook compliant data track.

20. The enhanced audio CD of claim 17 wherein no informational errors exist on the CD to make the CD non-compliant with Redbook, Yellowbook or Bluebook standards

21. The enhanced audio CD of claim 17 wherein information on the CD can be stored in a standard DDP file format and produced in a CD production facility without any special production requirements.

22. A method of limiting access to audio tracks on an enhanced audio CD which comprises making a multiple session enhanced audio CD having a first that contain audio tracks, a second session that contains a data track and one or more additional sessions.

23. The method of claim 22 wherein the first session is Redbook compliant.

24. The method of claim 22 wherein the first track of the second session is a Yellowbook compliant data track.

25. The method of claim 22 wherein no informational errors exist on the CD to make the CD non-compliant with Redbook, Yellowbook or Bluebook standards

26. The method of claim 22 wherein information on the CD can be stored in a standard DDP file format and produced in a CD production facility without any special production requirements.
